(19) United States
(12) Patent Application Publication
(10) Pub. No.: US 2007/0217086 A1
(43) Pub. Date: Sep. 20, 2007

(54) Magnetic sensor and magnetic disk storage unit

(75) Inventors: Masato Matsubara, Kawasaki (JP); Hideyuki Akimoto, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/488,495

(22) Filed: Jul. 18, 2006

(30) Foreign Application Priority Data
Mar. 15, 2006 (JP) 2006-70637

(51) Int. Cl. G11B 5/127; G11B 5/33

(52) U.S. Cl. 360/324.12

(57) ABSTRACT

The magnetic sensor is capable of improving variations of output power and asymmetric diversity of output signals of a magnetoresistance effect element. The magnetic sensor comprises hard films sandwiching the magnetoresistance effect element, and the hard films apply bias magnetic fields to the magnetoresistance effect element. Each of the hard films includes: a wide section, whose thickness in a height-direction is higher than that of the magnetoresistance effect film; and a link section, whose thickness in the height-direction is gradually reduced toward the magnetoresistance effect element, being extended from the wide section to a side face of the magnetoresistance effect element.

### BACKGROUND OF THE INVENTION

The present invention relates to a magnetic sensor for reproducing data and a magnetic disk storage unit using the magnetic sensor.

A conventional magnetic head of a magnetic disk storage unit is shown in FIG. 5. The magnetic head comprises: a read-head 8, in which a magnetoresistance effect element (MR element) 6 for reproducing data is sandwiched between a lower shielding layer 5 and an upper shielding layer 7; and a write-head 13, in which a write-gap 10 is sandwiched between a lower magnetic pole 9 and an upper magnetic pole 11. The write-head 13 further includes a coil 12 for writing data.

The magnetoresistance effect element has a free layer so as to detect magnetized data. Directions of magnetization (spin) of the free layer is reversed by an external magnetic field. The free layer is a magnetic layer whose spin directions are easily reversed by an external magnetic field. To correctly detect magnetized data, a bias magnetic field is applied to the free layer so as to orient the spin directions to a prescribed direction. Therefore, the spin directions are reversed when an external magnetic field is applied.

Conventionally, bias magnetic fields are applied to the free layer by sandwiching the magnetoresistance effect element between hard films (hard magnetic films) and applying fixed magnetic fields to the magnetoresistance effect element.

The conventional technology is shown in FIG. 1B, in which hard films 20 are respectively provided on the both sides of a magnetoresistance effect element 6. FIG. 1B is a sectional view showing sections of the magnetoresistance effect element 6 and the hard films 20 taken along a plane perpendicular to an air bearing surface of the magnetic head. Thicknesses of the hard films 20 in the height direction are equal to that of the magnetoresistance effect element 6 (see Japanese Patent Gazette No. 2002-208122).

By applying the bias magnetic fields to the free layer of the magnetoresistance effect element 6 with the hard films 20, variations of output power and asymmetric diversity of output signals of the magnetoresistance effect element 6 are highly influenced. If intensities of the bias magnetic fields applied by the hard films 20 are insufficient, the variations of the output power and the asymmetric diversity must be great, so that reproducing accuracy of the read-head must be lowered. Therefore, intensities of the bias magnetic fields applied by the hard films 20 must be higher. Conventionally, properties of magnetic materials, which constitute the hard films 20, have been studied to increase intensities of the bias magnetic fields.

However, it is very difficult to improve properties of magnetic materials of the hard films 20.

### SUMMARY OF THE INVENTION

The present invention was conceived to solve the above described problems of the conventional technology.

An object of the present invention is to provide a magnetic sensor, which is capable of improving variations of output power and asymmetric diversity of output signals of a magnetoresistance effect element by changing shapes of hard films, without improving properties of magnetic materials of the hard films.

Another object is to provide a magnetic disk storage unit employing the magnetic sensor in a magnetic head.

To achieve the objects, the present invention has following structures.

Namely, the magnetic sensor of the present invention comprises: a magnetoresistance effect element; and hard films sandwiching the magnetoresistance effect element, the hard films applying bias magnetic fields to the magnetoresistance effect element, and each of the hard films includes: a wide section, whose thickness in a height-direction is higher than that of the magnetoresistance effect film; and a link section, whose thickness in the height-direction is gradually reduced toward the magnetoresistance effect element, being extended from the wide section to a side face of the magnetoresistance effect element.

In the magnetic sensor, each of the hard films may further include a connecting section, which is extended from the link section and connected to the side face of the magnetoresistance effect element and whose thickness in the height-direction is equal to that of the magnetoresistance effect element.

The magnetic disk storage unit of the present invention comprises a carriage assembly, which includes: a slider, in which a magnetic head for writing data to and reading data from a recording medium is formed; and a suspension holding the slider at a front end, a read-head of the magnetic head comprises: a magnetoresistance effect element; and hard films sandwiching the magnetoresistance effect element, the hard films applying bias magnetic fields to the magnetoresistance effect element, and each of the hard films comprises: a wide section, whose thickness in a height-direction is higher than that of the magnetoresistance effect film; and a link section, whose thickness in the height-direction is gradually reduced toward the magnetoresistance effect element, being extended from the wide section to a side face of the magnetoresistance effect element.

In the magnetic disk storage unit, each of the hard films may further comprise a connecting section, which is extended from the link section and connected to the side face of the magnetoresistance effect element and whose thickness in the height-direction is equal to that of the magnetoresistance effect element.

In the magnetic sensor of the present invention, each of the hard films has the link section, whose thickness in the height-direction is gradually reduced toward the magnetoresistance effect element, so that variations of output power of the magnetoresistance effect element can be improved. The hard films can be easily formed into said shapes without changing a conventional production process. Thermal emissivity of the hard films can be improved, so that characteristics of the magnetoresistance effect element can be stable. Further, by using the magnetic sensor in the magnetic disk storage unit, the magnetic disk storage unit is capable of highly precisely reproducing data, so that reliability of the magnetic disk storage unit can be improved.

### BRIEF DESCRIPTION OF THE DRAWINGS

Embodiments of the present invention will now be described by way of examples and with reference to the accompanying drawings, in which:

FIG. 1A is an explanation view of an embodiment of the magnetic sensor of the present invention, in which a magnetoresistance effect element and hard films are shown;

FIG. 1B is an explanation view of the conventional magnetic sensor;

FIG. 2 is a graph showing variations of output powers of the magnetoresistance effect elements of the embodiment and the conventional magnetic sensor, which relate to solitary waves;

FIG. 3 is a graph showing variations of asymmetric diversities of output waveforms of the magnetoresistance effect elements of the embodiment and the conventional magnetic sensor, which relate to the solitary waves;

FIG. 4 is a plan view of the magnetic disk storage unit having a magnetic head which includes the magnetic sensor of the present invention; and

FIG. 5 is a sectional view of the conventional magnetic head.

### DETAILED DESCRIPTION OF THE EMBODIMENTS

Preferred embodiments of the present invention will now be described in detail with reference to the accompanying drawings.

### (Magnetic Sensor)

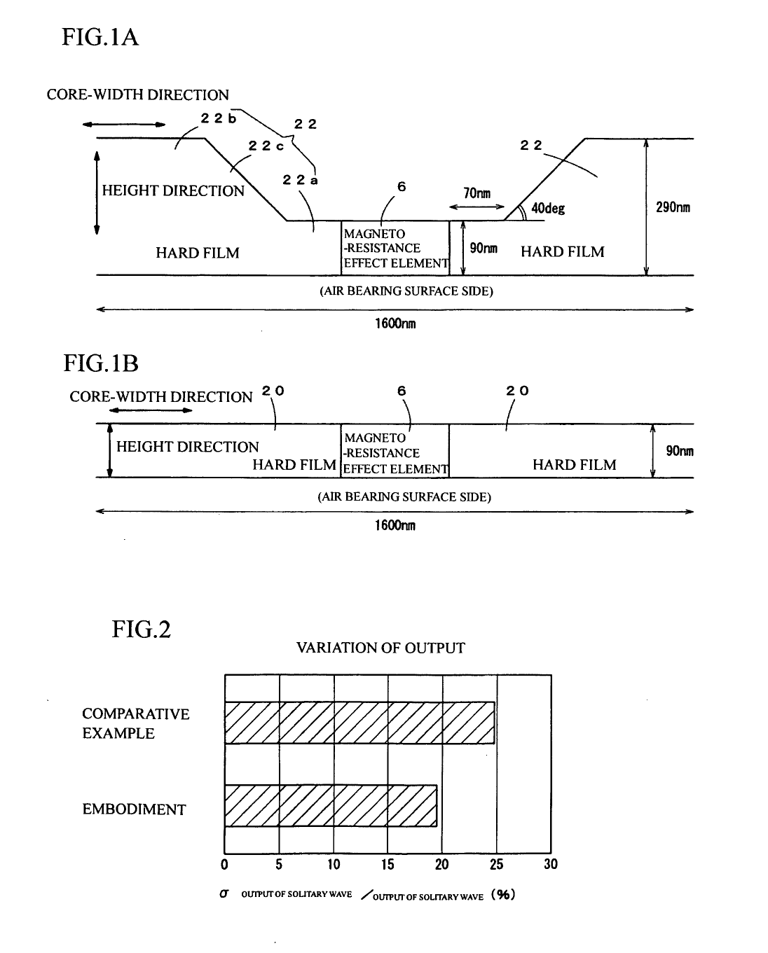

FIG. 1A shows a magnetoresistance effect element 6 and hard films 22, which constitute the magnetic sensor of the present invention. The hard films 22 are respectively provided on the both sides of the magnetoresistance effect element 6. Note that, FIG. 1B shows the magnetoresistance effect element 6 and the hard films 20 of the conventional magnetic sensor as a comparative example.

FIGS. 1A and 1B are sectional views taken along planes perpendicular to air bearing surfaces of the magnetic heads. Namely, each of the drawings shows the sectional view in the height directions and the core-width directions. In each of the magnetoresistance effect elements 6, magnetic layers including a free layer are layered in a direction perpendicular to a paper face of the drawing.

Various types of magnetic heads, e.g., a horizontal magnetic head, a perpendicular magnetic head, have been invented. The magnetic sensor of the present invention is characterized by the magnetoresistance effect elements 6 and the hard films 22, which is formed in a read-head of the magnetic head. The structures of the magnetoresistance effect elements 6 and the hard films 22 can be applied to various types of magnetic heads without reference to structures of write-heads.

As shown in FIG. 1A, the unique feature of the magnetic sensor is shapes of the hard films 22, which sandwich the magnetoresistance effect elements 6.

In the conventional magnetic sensor shown in FIG. 1B, thicknesses of the hard films 20 in the height direction are equal to that of the magnetoresistance effect elements 6. On the other hand, in the present embodiment, thicknesses of connecting sections 22a of the hard films 22 in the height direction are equal to that of the magnetoresistance effect elements 6; thicknesses of wide sections 22b, which are located on the outer sides of the connecting sections 22a, in the height direction is thicker than that of the magnetoresistance effect elements 6. The connecting sections 22a are respectively connected to the wide sections 22b by link sections 22c.

Lower faces of the magnetoresistance effect elements 6 and the hard films 22, which face the air bearing surface, are made linearly flat. By providing each link section 22c between the connecting section 22a and the wide section 22b, the thickness of each hard film 22 is gradually reduced from the wide section 22b to the connecting section 22a. Namely, the connecting sections 22a, which sandwich the magnetoresistance effect elements 6, are the thinnest sections of the hard films 22, and upper faces of the link sections 22b are slope faces.

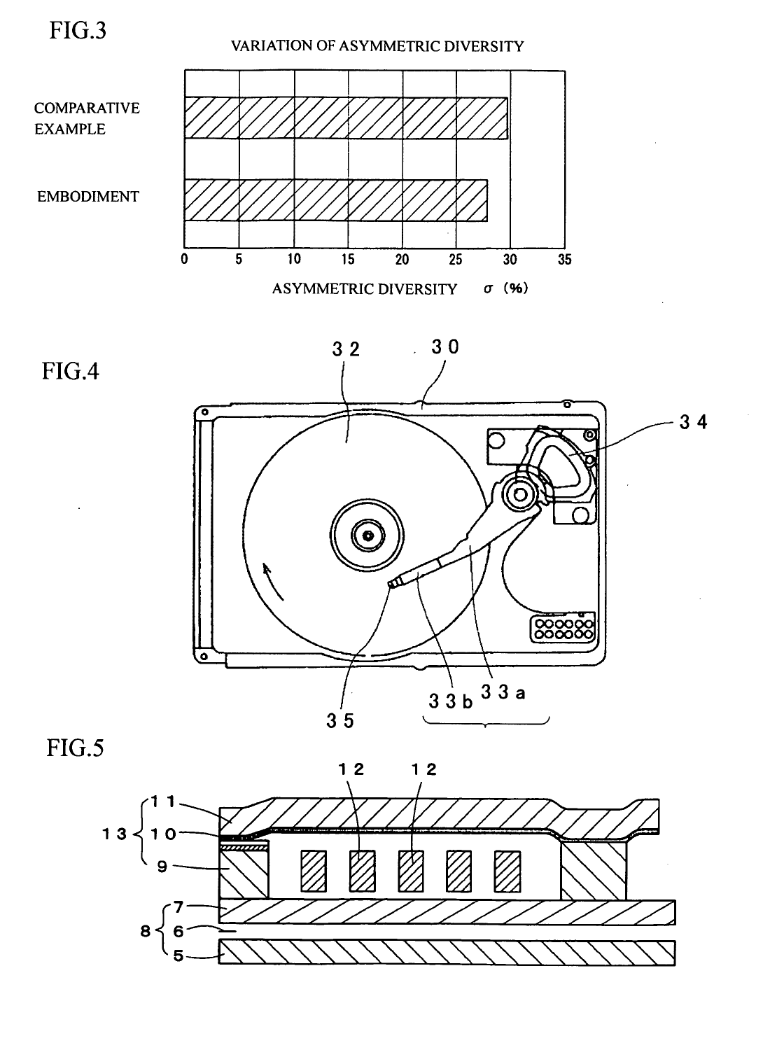

FIG. 2 shows variations of output powers of the magnetoresistance effect element 6 of the present embodiment (see FIG. 1A) and the magnetoresistance effect element 6 of the conventional magnetic sensor (see FIG. 1B). FIG. 3 shows variations of asymmetric diversities of output waveforms of the magnetoresistance effect element 6 of the embodiment (see FIG. 1A) and the magnetoresistance effect element 6 of the conventional magnetic sensor (see FIG. 1B). The variations were gained by calculations.

In FIGS. 2 and 3, “EMBODIMENT” was the magnetic sensor shown in FIG. 1A; “COMPARATIVE EXAMPLE” was the conventional magnetic sensor shown in FIG. 1B. In the magnetic sensor of EMBODIMENT, the thickness of the magnetoresistance effect element 6 in the height direction was 90 nm; the thickness of each connecting section 22a was 90 nm; a length thereof was 70 nm; the thickness of each wide section 22b was 290 nm; an angle of the slope face of each link section 22c was 40 degrees; and a length between outer ends of the hard films 22 was 1600 nm. On the other hand, in the conventional magnetic sensor of COMPARATIVE EXAMPLE, the thicknesses of the magnetoresistance effect element 6 and the hard films 20 in the height direction were 90 nm; and a length between outer ends of the hard films 20 was 1600 nm. The hard films 20 and 22 were made of CoCrPt. The calculations were performed in consideration of variations of particle diameters of the hard films 20 and 22.

In FIG. 2, the variations σ of output powers are indicated as percentage with respect to solitary wave outputs. In the magnetic sensor of EMBODIMENT having the hard films 22, an average solitary wave output was 5100 μv; and a percentage of variation of the outputs was 19.5%. On the other hand, in the magnetic sensor of COMPARATIVE EXAMPLE having the hard films 20, an average solitary wave output was 5100 μv; and a percentage of variation of the outputs was 24.7%. By comparing the variations of the outputs, the percentage of variation of EMBODIMENT was improved about 21% with respect to COMPARATIVE EXAMPLE.

Next, the asymmetric diversities of output waveforms of solitary waves were calculated. In the magnetic sensor of EMBODIMENT, a variation range of asymmetric diversities was 23.8%; and a percentage of variations of the asymmetric diversities was 27.9%. On the other hand, in the conventional magnetic sensor of COMPARATIVE EXAMPLE, a variation range of asymmetric diversities was 32.4%; and a percentage of variations of the asymmetric diversities was 29.7% (see FIG. 3). By comparing the percentages of the variations of the asymmetric diversities, the percentage of EMBODIMENT was improved about 5.7% with respect to COMPARATIVE EXAMPLE.

According to the results shown in FIGS. 2 and 3, the shapes of the hard films, which sandwich the magnetoresistance effect element, effectively improve magnetic characteristics of the magnetoresistance effect element.

Namely, the thicknesses of the wide sections of the hard films, which sandwich the magnetoresistance effect element, are thicker than that of the magnetoresistance effect element, and the thicknesses of the link sections thereof are gradually reduced toward side faces of the magnetoresistance effect element. With this structure, intensities of bias magnetic fields, which are applied to the magnetoresistance effect element by the hard films, can be increased, so that the variations of output powers and asymmetric diversities of the magnetoresistance effect element can be improved.

As shown in FIG. 1A, the thicknesses of the hard films 22, which sandwich the magnetoresistance effect element 6, is thicker than that of the magnetoresistance effect element 6. With this structure, area of the hard films 22 is broader than that of the hard films 20, whose thickness in the height direction is equal to that of the magnetoresistance effect element 6, so that thermal emissivity of the hard films 22 can be improved.

When the magnetic head contacts a surface of a recording medium which is rotating, friction therebetween rises temperature of the magnetic head. In the present embodiment, the area of the hard films 22 are made broad so as to improve the thermal emissivity. Even if the friction rises the temperature of the magnetic head, overheating the magnetoresistance effect element 6 can be prevented so that outputs of the magnetoresistance effect element 6 can be stable.

In the present embodiment, the thicknesses of the hard films 22 in the height direction is made thicker (higher) so as to improve magnetic characteristics of the magnetoresistance effect element 6. The change of the shapes of the hard films 22 can be easily performed. Therefore, the hard films 22 can be can be produced without changing a conventional production process. This is also a big effect of the present invention. Further, magnetic characteristics of the magnetoresistance effect element 6 can be further improved by changing shapes and properties of the hard films 22.

### (Magnetic Disk Storage Unit)

FIG. 4 shows an embodiment of the magnetic disc storage unit of the present invention, which uses the above described magnetic sensor. The magnetic disc storage unit comprises: a box-shaped casing 30; a recording medium (magnetic disk) 32 accommodated in the casing 30; a mechanism for rotating the recording medium 32; a carriage assembly 33; and an actuator 34 for seek-moving the carriage assembly 33. The carriage assembly 33 comprises: a carriage arm 33a: a suspension 33b attached to the carriage arm 33a; and a slider 35, which has the magnetic head including the magnetic sensor of the present invention, provided to a front end of the suspension 33b.

In the magnetic disc storage unit, a write-head of the magnetic head of the slider 35 writes data in the recording medium 32; a read-head thereof reproduces data written in the recording medium 32. The read-head includes the above described magnetoresistance effect element 6 and the hard films 22, so that he magnetic disk storage unit is capable of highly precisely reproducing data.

The invention may be embodied in other specific forms without departing from the spirit of essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A magnetic sensor,
comprising:
a magnetoresistance effect element; and
hard films sandwiching said magnetoresistance effect element, said hard films applying bias magnetic fields to said magnetoresistance effect element,
wherein each of said hard films includes:
a wide section, whose thickness in a height-direction is higher than that of said magnetoresistance effect film; and
a link section, whose thickness in the height-direction is gradually reduced toward said magnetoresistance effect element, being extended from the wide section to a side face of said magnetoresistance effect element.

2. The magnetic sensor according to claim 1,
wherein each of said hard films further includes a connecting section, which is extended from the link section and connected to the side face of said magnetoresistance effect element and whose thickness in the height-direction is equal to that of said magnetoresistance effect element.

3. A magnetic disk storage unit,
comprising a carriage assembly, which includes: a slider, in which a magnetic head for writing data to and reading data from a recording medium is formed; and a suspension holding the slider at a front end,
wherein a read-head of the magnetic head comprises: a magnetoresistance effect element; and hard films sandwiching said magnetoresistance effect element, said hard films applying bias magnetic fields to said magnetoresistance effect element, and
wherein each of said hard films comprises: a wide section, whose thickness in a height-direction is higher than that of said magnetoresistance effect film; and a link section, whose thickness in the height-direction is gradually reduced toward said magnetoresistance effect element, being extended from the wide section to a side face of said magnetoresistance effect element.

4. The magnetic disk storage unit according to claim 3,
wherein each of said hard films further comprises a connecting section, which is extended from the link section and connected to the side face of said magnetoresistance effect element and whose thickness in the height-direction is equal to that of said magnetoresistance effect element.
